(19) United States
(12) Patent Application Publication
(10) Pub. No.: US 2009/0133324 A1
(43) Pub. Date: May 28, 2009

(54) HORTICULTURAL APPARATUS

(76) Inventor: Humphrey Richard Ian Cannon, Derbyshire (GB)

Correspondence Address: NOTARO & MICHALOS P.C., 100 DUTCH HILL ROAD, SUITE 110, ORANGEBURG, NY, 10962-2100, US

(21) Appl. No.: 12/294,085

(22) PCT Filed: Mar. 26, 2007
(86) PCT No.: PCT/GB2007/001062

§ 371 Date: Dec. 12, 2008

(30) Foreign Application Priority Data
Apr. 1, 2006 (GB) 0606640.1

(51) Int. Cl. A01G 13/02

(52) U.S. Cl. 47/29.3

(57) ABSTRACT

The apparatus comprises a compositing bin (10), which may be constructed from modular elements (13), provided with a perforated or slatted floor (14) of a bedding frame (11) incorporated over the bin (10). The frame (11) is covered by a pyramidal roof structure (12), of translucent plastics panels, these can be connected into pairs by flexible tapes (18), the other edges being connected by tapes (19) incorporating sliding clasp fasteners (20). The bottom edges of the panels may be provided on their inner sides with channels (17) to trap condensation, and the edges of the panels may be reinforced by rods or dowels (22) in tunnel seams in the tapes (18, 19).

This invention relates to new and improved horticultural apparatus.

In horticultural plant husbandry, it is a well known practise to prepare seedlings and cuttings for later planting out by carrying out their first stages of growth in a propagator or cold frame. A cold frame is a glazed structure over a garden bed which is not subject to artificial heating, (as opposed to a hot house which is artificially heated). Both the cold frame and propagator enclose a volume of air over the plants, whilst solar radiation is allowed to penetrate the glass. Re-radiation of solar energy by the plants as longer wave infra red heat radiation is trapped by the glass however, and a favourable micro-climate is created within the frame which promotes early growth and helps to withstand frost.

The manufacture of compost for use as garden fertiliser is also widely practised. The process usually comprises the steps of gradually loading a bin or other container, or a fenced enclosure, with organic waste mainly garden plant refuse possibly with the use of promoters and enrichers. When the bin, container, or enclosure is filled, it is left for a period of time to rot down. The final stage is to spread the resulting compost on the garden for use as a fertilizer.

During the rotting down stage, the composting material generates heat, and emits gases such as methane and carbon dioxide.

It is an object of the invention to provide horticultural apparatus whereby waste and heat and gases arising from a composting process may be made use of to enhance plant husbandry in a plant shelter such as a propagator or cold frame.

According to the invention horticultural apparatus comprises a receptacle for compost, a support for one or more plant growth receptacles above the receptacle for compost, and a light permeable heat retaining cover for the plant growth receptacle or receptacles.

The support for one or more plant growth receptacles may comprise a lid for the compost receptacle which provides a support upon which plant pots, or planters or a raised bed structure may be supported. The lid may be provided with apertures, or slatted, to allow gases generated by the composting process to be admitted into the space above the support.

The compost receptacle may be of a modular construction, for example using structural elements such as described in EP-A-1069253.

The cover may be a glass cloche or conventional propagator or cold frame, but is preferably a demountable roof structure having panels of clear plastics material, of any suitable geometry.

In a preferred embodiment, the cover is in the form of a pyramid having a square base, and four triangular clear plastics panels. Each panel may be formed with a lower edge structure along its base edge which provides a gutter to trap condensation from the inner surface of the panel.

Each of the upwardly extending edges of each panel may be formed with a tunnel seam which receives a reinforcing rod of an appropriate material, e.g. metal or a suitable plastics material.

The panels may be secured in pairs by joining along abutting upward edges by a flexible plastics tape, which may be fabric or fibre reinforced, whilst the remaining edges may be connected to corresponding edges of a second pair of panels by sliding clasp fasteners (“zips”) so that the cover may be opened from alternative positions fully or partially, for access to the interior of the cover to tend and water plants, or remove plants or place new ones.

Each corner of the cover may be secured to the bin structure by means of a hook which engages in a detent provided at the respective corner of the bin structure, and holes may be provided on the upper edge of the structure to receive the ends of the reinforcing rods.

An extractor fan, powered by solar energy, may be provided at the apex of the cover to cool the interior under strong sun conditions. The geometry of the cover could of course be varied, e.g. it could be in the form of a polygonal pyramid (e.g. hexagonal or octagonal) with a correspondingly shaped compost container, and a corresponding number of interconnected triangular panels.

Alternatively, the cover could provide a single sloping panel, like a conventional cold frame, or a ridge roof form, with two long rectangular panels, and two triangular end panels.

An embodiment of horticultural apparatus according to the invention will now be described with reference to the accompanying drawings, wherein:—

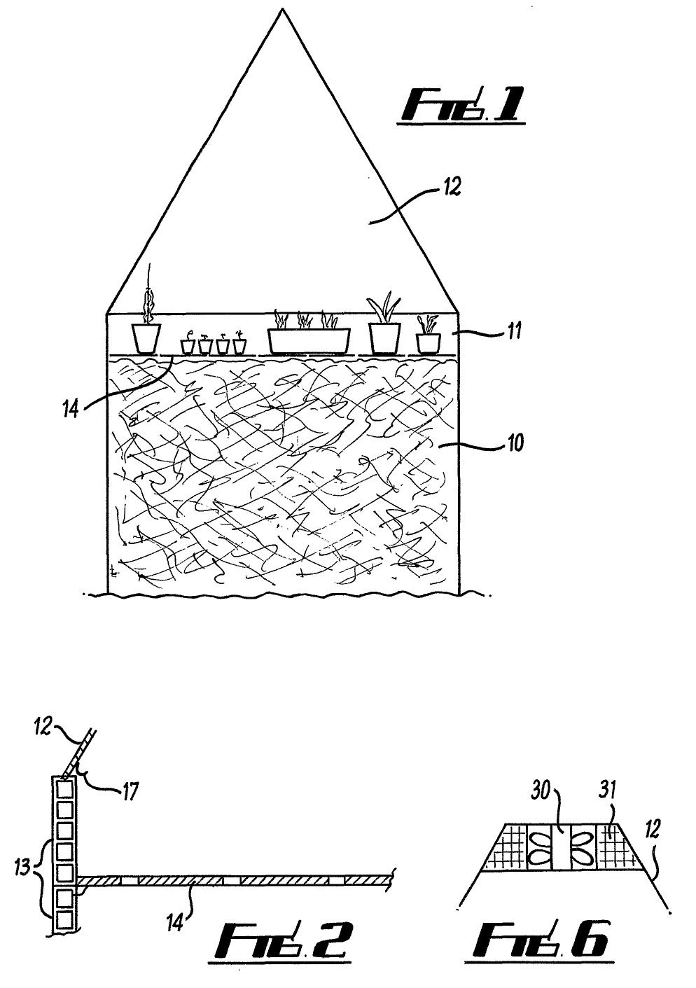

FIG. 1 is a diagrammatic sectional view from one side of an embodiment of horticultural apparatus according to the invention;

FIG. 2 is a fragmentary cross-sectional view showing part of the structure of the apparatus;

FIG. 3 is a perspective view of a cover forming part of the apparatus;

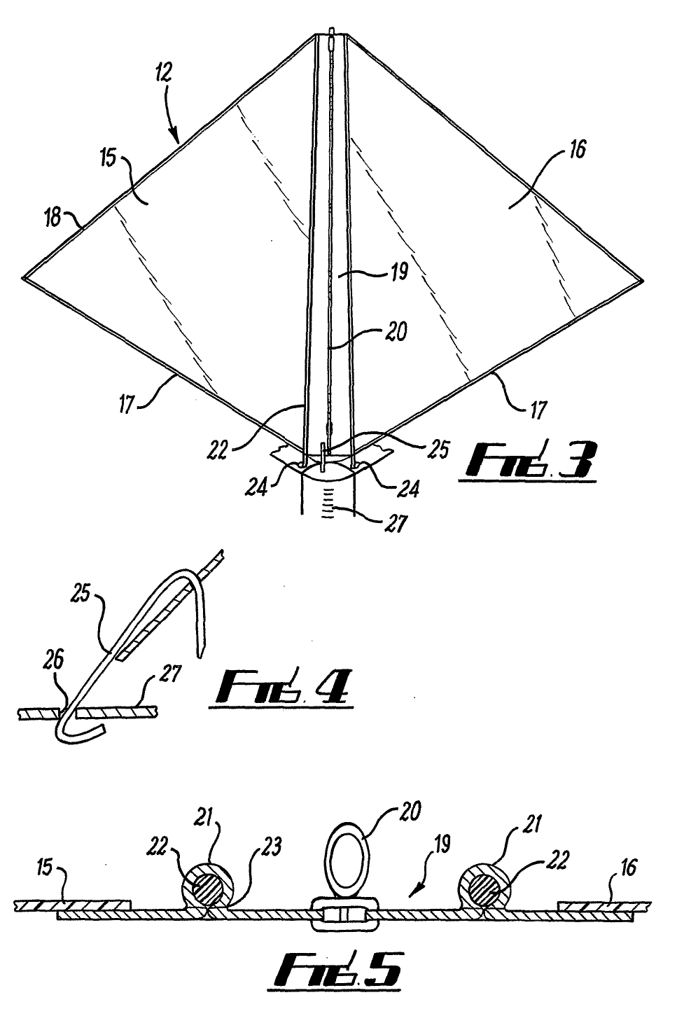

FIG. 4 is a fragmentary cross-sectional view showing an anchor for a corner of the cover;

FIG. 5 is a sectional view of the means used for joining two panels of the cover side by side; and

FIG. 6 is a cross-sectional view of a modified version of the FIG. 1 embodiment, showing only the apex of the cover thereof.

Horticultural apparatus according to the invention comprises essentially a combined compost bin and propagator or cold frame, and comprises a compost bin structure 10, a bedding frame 11 carried on top thereof, and a cover or cloche 12 over the frame 11.

In the preferred embodiment, the bin structure 10 and bedding frame 11 are fabricated from LINK-A-BORD (Registered Trade Mark) which is described in EP-A-1069253. The frame 11 is in effect comprised by an additional tier of LINK-A-BORD elements 13 (see FIG. 2), which also provide a support for a floor 14 which is preferably a perforated sheet.

The floor 14 could alternatively be formed of spaced apart slats, metal or plastics mesh, or the like.

The cover 12 comprises a pyramidal construction of four equilateral triangular panels 15, 16 of a translucent, preferably transparent, plastics sheet material. The plastics may incorporate a photochromic material to block out higher frequency radiation from violet into the ultra violet spectrum to filter out mutagenic radiation.

FIG. 6 shows in diagrammatic form an optional, but preferred modification of the embodiment of FIG. 1. FIG. 6 shows only the apex of the cover 12, which is truncated with respect to FIG. 1, so that the point of the pyramid is removed. An extractor fan 30 is arranged in the truncated apex and this is arranged to be driven by means of electricity generated by photo-voltaic cells 31 disposed over the top ends of the faces of the pyramid, and the upper surface of the fan housing. This fan 30 will operate to cool the interior of the cover 12 under conditions of strong sunshine which would otherwise cause overheating of the interior, and also provides the energy to operate the fan. The fan is not likely to be needed except in sunny conditions, when solar energy is available.

This will avoid cooking of the plants, especially during holiday times as the gardener may be unable to ventilate the cover due to absence. The carbon dioxide will also be enriched as the plants photosynthesise faster with increased solar summer radiation.

Each panel 15, 16 has a channel 17 along the inner side of its lower edge to trap condensation running down the inner face of the panel and to direct the condensation to a reservoir which includes a wicking medium, to recycle the moisture.

The panels of the cover are joined by tapes to form two pairs of panels. One tape 18 simply provides a flexible hinged connection between adjacent panels 15, 16 of the pair, whilst the other sloping edges of the panels are connectable by tapes 19 to corresponding edges of panels 16, 15 of the other pair. These tapes feature sliding clap fasteners of the “zip” type, 20, which can be completely separated so that the pairs of panels are openable both for access to the interior of the frame, and for complete removal of the cover 12.

The tapes 18, 19 provide tunnel seams 21 alongside the edge of each respective panel to receive a rigid plastics rod or dowel 22 which acts as a stiffener or reinforcement for the panel and these combined provide a frame for the pyramidal construction.

FIG. 5 shows a tape 19 in cross section, and this comprises a strip of for example fabric-backed or reinforced plastics sheet which is welded at each edge to the respective edges of the translucent panels 15, 16. The tunnel seams 21 and rods 22 are shown, and these may be secured by stitching as at 23, or by welds. The tape 19 comprises two halves which are joined by the sliding clasp fastener 20. Tapes 18 are similar without the fastener 20.

The ends of the rods or dowels 22 are received in holes 24 in the upper edge of the structural elements 13 adjacent each corner, and a hook 25 is connected between a hole in each tape 18, 19 and received in a hole 26 in the upper end of the respective corner piece 27 (see detail of FIG. 3 and FIG. 4).

The details of the construction may be varied, and be made using other construction systems or components, and the geometry of the cover and bin may be varied.

The compost bin 10, is as conventional, filled with biodegradable garden waste over a period, and then when full, an additional tier of LINK-A-BORD is placed on top, incorporating the bedding frame 11, and covered with the cover 12.

The composting process releases heat and gases such as methane and carbon dioxide, which together with sunlight via the cover 12, create a micro-environment within the bedding frame which is favourable to plant growth, and more favourable than a conventional ground located cold frame, or cloche. Photosynthesis by the plants within the frame 11 uses up the carbon dioxide, and indeed is promoted by the excess produced by the compost bin. The air may be vented at the top of the cover 12, after removal of the CO₂ excess in this way. The construction is thus suitable to promote growth of cuttings and seedlings and bring forward flowering plants for planting out.

1: Horticultural apparatus comprising a receptacle for compost, a support for one or more plant growth receptacles above the receptacle for compost, and a light permeable, heat retaining cover for the plant growth receptacle or receptacles.

2: Apparatus according to claim 1, wherein the support for one or more plant growth receptacles comprises a lid for the compost receptacle, said lid providing a support upon which plant pots, planters or a raised bed structure can be supported.

3: Apparatus according to claim 2 wherein the lid is provided with apertures to allow gases generated by the compositing process to be admitted into the space above the support.

4: Apparatus according to claim 3 wherein the apertures are provided by the lid being slatted.

5: Apparatus according to claim 1 wherein the cover comprises a demountable roof structure having one or more panels of clear plastics material.

6: Apparatus according to claim 5 wherein the roof structure is in the form of a pyramid having a square base and four substantially triangular clear plastics panels.

7: Apparatus according to claim 6 wherein each panel is formed with a lower edge structure along its base edge which provides a gutter to trap condensation from the inner surface of the panel.

8: Apparatus according to claim 6, wherein each of the upwardly extending edges of each panel is formed with a tunnel seam which receives a reinforcing rod of an appropriate material.

9: Apparatus according to claim 6 wherein the panels are secured in pairs by joining along abutting upward edges by a flexible plastics tape.

10: Apparatus according to claim 9 wherein the remaining edges are connected to corresponding edges of a second pair of panels by sliding clasp fasteners, so that the cover may be opened from alternative positions, fully or partially, for access to the interior of the cover to tend and water plants, or remove plants or place new ones.

11: Apparatus according to claim 10 wherein each corner of the cover is secured to the receptacle for compost, which is in the form of a bin, by means of a hook which engages in a detent provided at the respective corner of the bin, and holes are provided in the upper edge of the bin to receive the ends of the reinforcing rods.

12: Apparatus according to claim 6, wherein an extractor fan, powered by solar energy is provided at the apex of the cover, to cool the interior under strong sun conditions.

13: Apparatus according to claim 5 wherein the roof structure comprises a polygonal pyramid of more than four sides, with a correspondingly shaped compost container, and a corresponding number of interconnected triangular panels.

14: Apparatus according to claim 5 wherein the roof structure comprises a single sloping panel, or a ridge-roof form comprising two long rectangular panels and two triangular end panels.
